(19) United States
(12) Patent Application Publication
(10) Pub. No.: US 2015/0234546 A1
(43) Pub. Date: Aug. 20, 2015

(54) Method for Quickly Displaying a Skype Contacts List and Computer Program Thereof and Portable Electronic Device for Using the Same

(71) Applicants: Hong-Lin Lee, Taipei (TW); Wen-Hsiung Tsai, Taipei (TW); Tzi-I Yang, Taipei (TW)

(72) Inventors: Hong-Lin Lee, Taipei (TW); Wen-Hsiung Tsai, Taipei (TW); Tzi-I Yang, Taipei (TW)

(21) Appl. No.: 14/182,317

(22) Filed: Feb. 18, 2014

(51) Int. Cl. G06F 3/0482; G06F 3/0484

(52) U.S. Cl. CPC G06F 3/0482; G06F 3/04842

(57) ABSTRACT

A method for quickly displaying a Skype contacts list applied to a portable electronic device is disclosed. The method for quickly displaying a Skype contacts list includes the following steps: receiving a command generated by a user touching a physical button, and outputting a Skype contacts menu interface to a screen according to the command, wherein the Skype contacts menu interface includes a plurality of contacts button icons.

### BACKGROUND OF THE INVENTION

1. Field of the Invention

The present invention relates to a method for quickly displaying a Skype contacts list, and in particular relates to a method for quickly displaying a Skype contacts list where a user is allowed to access a Skype contacts menu interface promptly and conveniently.

2. Description of the Related Art

With the rapid development of technology, voice calls are not limited to making a call via a telephone; rather, it is also possible to make a call via the Internet. As a result, the Skype Internet communication application has become a popular application among users.

The Skype Internet communication application is loaded in a user's mobile phone, and an icon is displayed on the desktop on a screen for the user to access. The icon is selected by the user in order to launch the application. However, switching between screens and locating the application icon can be inconvenient to users who often use the Skype Internet communication application. When the user desires to search the contacts list, the user is required to click on the application icon or access the Skype application interface, which is inconvenient. Accordingly, it is desirable to provide an electronic device which is customized to execute the Skype Internet communication application such that the user needs only to press a physical button of the electronic device one time in order to quickly access the Skype contacts list, which can facilitate the process of a user making a Skype phone call.

### SUMMARY OF THE INVENTION

An object of the present invention is to provide a method for quickly displaying a Skype contacts list in order to provide quick access to the Skype contacts menu interface for using the Skype communication service.

Another object of the present invention is to provide a computer program for executing the method for quickly displaying a Skype contacts list of the present invention.

Yet another object of the present invention is to provide a portable electronic device for executing the method for quickly displaying a Skype contacts list of the present invention.

In order to achieve the above objects, the method for quickly displaying a Skype contacts list of the present invention is applied to a portable electronic device for a user to use. The portable electronic device includes a screen and a physical button. The physical button is located on one side of the screen, and the physical button is equally distant from the corresponding two sides of the portable electronic device. The method for quickly displaying a Skype contacts list of the present invention includes the following steps: receiving a command generated by the user touching the physical button, and outputting a Skype contacts menu interface on the screen according to the command, wherein the Skype contacts menu interface includes a plurality of contacts button icons for the user to make a phone call.

The present invention also provides a computer program. When the computer loads and executes the computer program, the computer is able to complete the above-mentioned method for quickly displaying a Skype contacts list.

The portable electronic device of the present invention includes a screen, a physical button, a memory and a processor, wherein the memory is used for storing the above-mentioned computer program for executing the method for quickly displaying a Skype contacts list. The processor is electrically coupled to the physical button and the memory. The processor is used for executing the computer program to complete the method for quickly displaying a Skype contacts list of the present invention.

### BRIEF DESCRIPTION OF THE DRAWINGS

The exemplary embodiments of the present invention will be understood more fully from the detailed description given below and from the accompanying drawings of various embodiments of the invention, which, however, should not be taken to limit the invention to the specific embodiments, but are for explanation and understanding only.

In the drawings, wherein similar reference numerals denote similar elements throughout the several views:

FIG. 1 is a schematic diagram of a portable electronic device loaded with a computer program according to the present invention;

FIG. 2 is a schematic diagram of step flowchart of the method for quickly displaying a Skype contacts list according to the present invention;

FIG. 3 is a schematic diagram of the user pressing the physical button;

FIG. 4 is a schematic diagram where the Skype contacts menu interface is displayed immediately after the user presses the physical button;

FIG. 5 is a schematic diagram of the user updating the contacts data by means of touch control; and

FIG. 6 is a schematic diagram of an updated contacts list.

### DETAILED DESCRIPTION OF THE PREFERRED EMBODIMENT

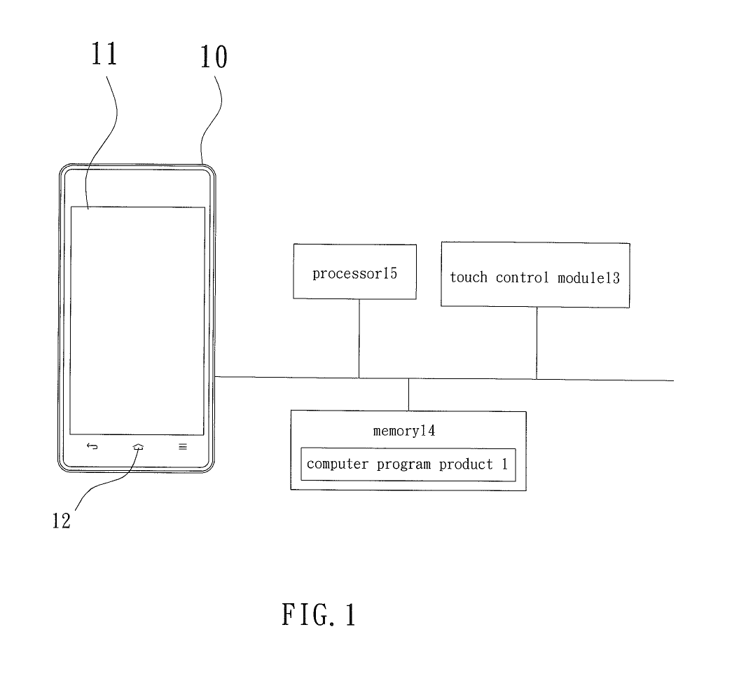

Please refer to FIG. 1, which is a schematic diagram of the computer program of the present invention applied to a portable electronic device.

As shown in FIG. 1, in one embodiment of the present invention, the computer program 1 used for executing the method for quickly displaying a Skype contacts list is applied to a portable electronic device 10. The portable electronic device 10 comprises a screen 11, a physical button 12, a touch control module 13, a memory 14 and a processor 15. According to a specific embodiment of the present invention, the portable electronic device 10 is a smart phone, but the scope of the present invention is not limited thereto. The portable electronic device 10 can also be a tablet computer or an electronic product with similar computing capabilities.

As shown in FIG. 1, the physical button 12 is located on the underside of the screen 11, and the physical button 12 is equally distant from the corresponding two sides of the portable electronic device 10. Specifically, the physical button 12 is the HOME button of a smart phone. The touch control module 13 is electrically connected to the screen 11, and the touch control module 13 is used for generating control signals when a user touches or clicks on the screen. In a specific implementation, the touch control module 13 and the screen 11 are integrated as a touch control screen. The memory 14 is used for storing the computer program 1 of the present invention. The processor 15 is electrically connected to the physical button 12, the touch control module 13 and the memory 14. When the processor 15 loads and executes the computer program 1, the portable electronic device 10 completes the method for quickly displaying a Skype contacts list of the present invention.

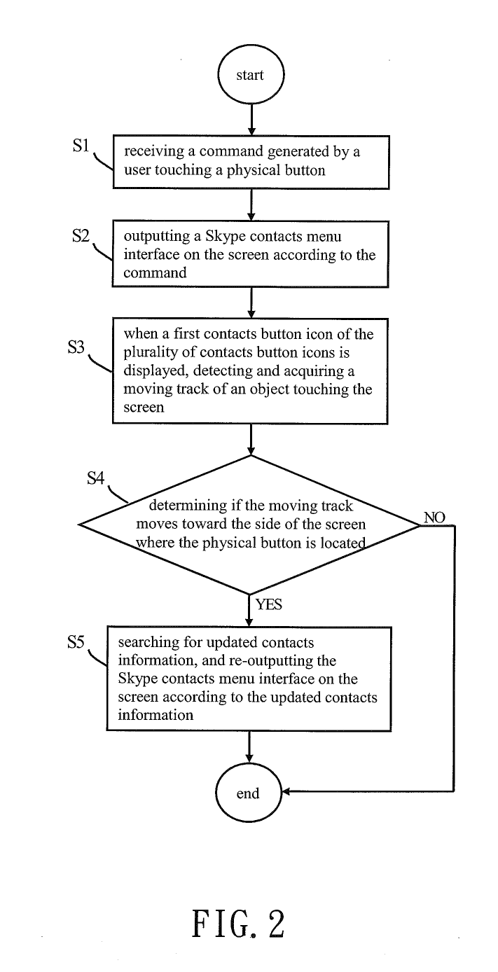

Refer to FIG. 2, FIG. 1 and FIG. 3-6, wherein FIG. 2 is a schematic diagram of a step flowchart of the method for quickly displaying a

Skype contacts list according to the present invention. The steps shown in FIG. 2 are illustrated along with FIG. 1 and FIG. 3-6; it should be noted that the portable electronic device 10 is used as an example for demonstrating the method for quickly displaying a Skype contacts list disclosed in the present invention, but the method is not limited to use in the above-mentioned portable electronic device 10 only.

First, step S1 is executed: receiving a command generated by a user touching a physical button.

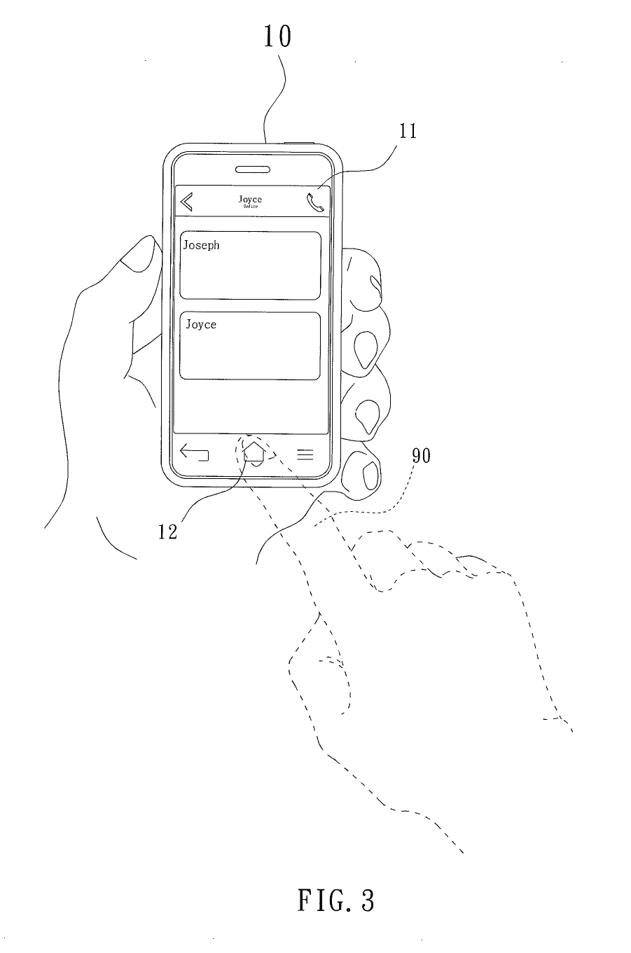

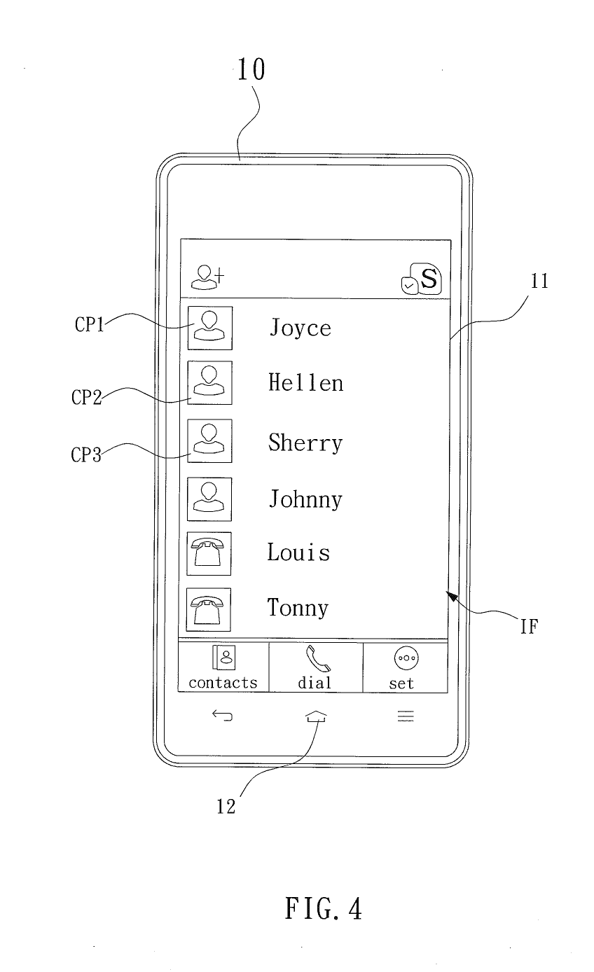

The present invention provides a method for conveniently and quickly accessing a Skype contacts menu interface such that a user can quickly access a Skype contacts list for searching the contacts list via touching a physical button 12 on a portable electronic device 10. As shown in FIG. 3 and FIG. 4, when the user wants to use the free communication provided by Skype, the user needs only to touch the physical button 12, and he/she can quickly access the Skype contacts menu interface. After the user touches the physical button 12, the processor 15 of the portable electronic device 10 then receives the command generated by the user touching the physical button 12.

Next, step S2 is executed: outputting a Skype contacts menu interface on the screen according to the command.

As shown in FIG. 4, after the processor 15 receives the command, the processor 15 outputs a Skype contacts menu interface IF on the screen 11 according to the command (i.e., the Skype contacts menu interface IF is displayed on the screen 11), wherein the Skype contacts menu interface IF comprises a plurality of contacts button icons CP1, CP2, CP3, and a certain number of contacts button icons CP1, CP2, CP3 are displayed on the screen 11 each time. The user can use one or more fingers or a stylus to touch the screen 11 and swipe upwards. At this time, the computer program displays a corresponding amount of contacts button icons CP1, CP2, CP3 on the screen. When the user clicks any of the contacts button icons CP1, CP2, CP3, the screen displays buttons indicating various communication modes, including making a free voice call, making a free video call, sending an instant text message, dialing out Skype Out calls, and sending a Skype Out text message (not shown in the diagrams). After the user further clicks on one of the communication mode buttons, the user is able to quickly access the associated Skype functions.

Step S3: when a first contacts button icon of the plurality of contacts button icons is displayed, detecting and acquiring a moving track of an object touching the screen.

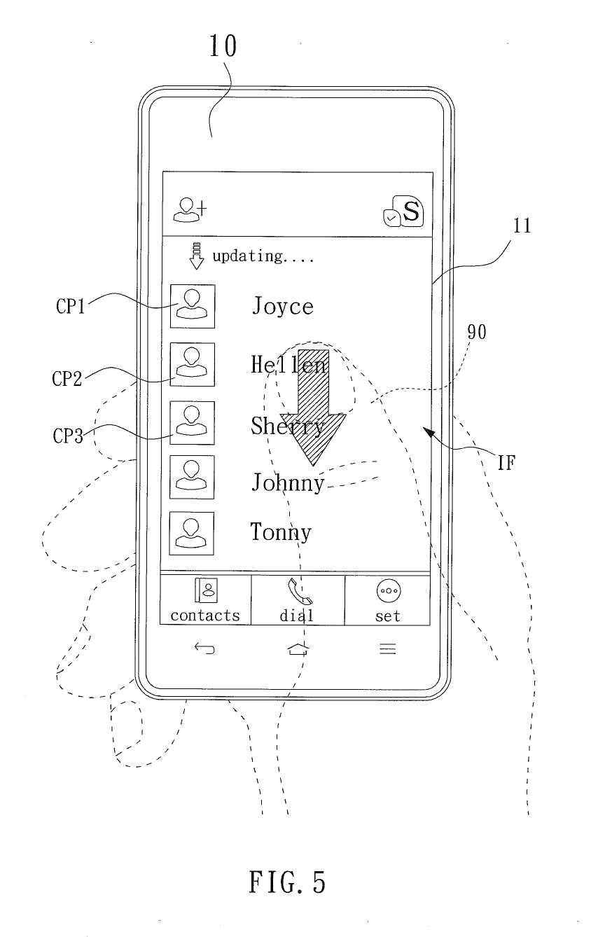

As shown in FIG. 5, after the Skype contacts menu interface IF is displayed on the screen 11, the user further updates the contacts data in addition to searching contacts via the above-mentioned touch control means.

When the Skype contacts menu interface IF is displayed on the screen 11, and a first contacts button icon (such as the CP1 shown in FIG. 5) of a plurality of contacts button icons CP1, CP2, CP3 is displayed on the screen image, the processor 15 detects and acquires a moving track (as the arrow shown in FIG. 5) of an object 90 (for example: a user's finger(s) or a stylus) touching the screen 11 via the touch control module 13. The first contacts button icon refers to the contacts button icon located at the top of the list of contacts button icons CP1, CP2, CP3. In other words, upon the user accessing the Skype contacts menu interface IF, and before the displayed screen image is changed by the user, the contacts button icon CP1 at the top of the screen image is the first contacts button icon.

Step S4: determining if the moving track moves toward the side of the screen where the physical button is located.

After executing step S3, the processor 15 further determines the motion direction of the object 90 according to the moving track to determine if the object 90 moves toward the bottom of the screen 11 (i.e., toward the location of the physical button 12, shown as the arrow direction in FIG. 5), and then determines if step S5 is to be executed.

Step S5: searching for updated contacts information, and re-outputting the Skype contacts menu interface on the screen according to the updated contacts information.

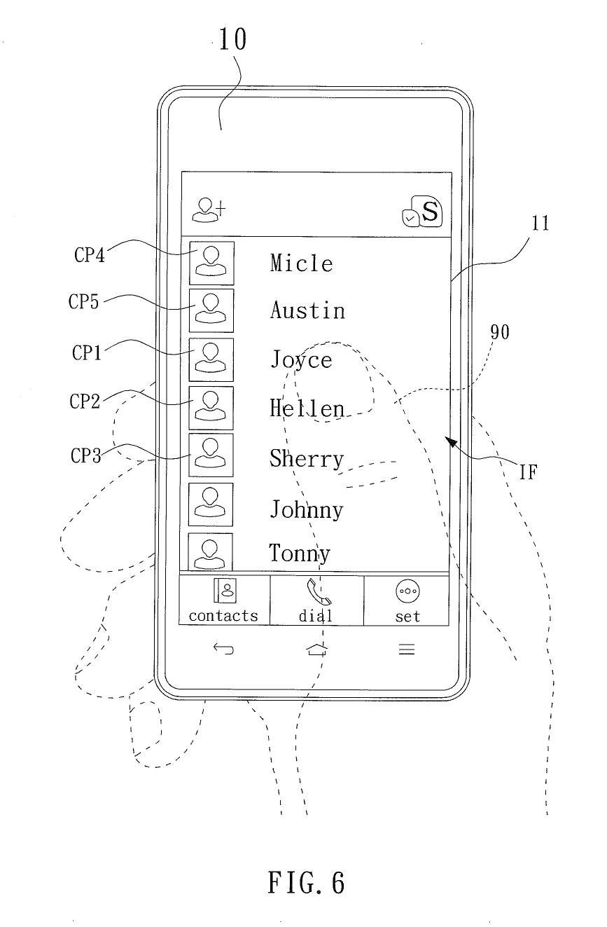

As shown in FIG. 5 and FIG. 6, as long as the above-mentioned steps S3˜S4 are executed, and the processor 15 determines that the object 90 moves toward the bottom of the screen 11 (as the arrow shown in FIG. 5), the processor 15 determines whether contacts information is added. For example, when a contact saved in the SIM card registers for Skype services, the processor 15 can obtain the updated contact information via the Internet and re-output an updated Skype contacts menu interface IF on the screen 11 according to the updated contacts information. Consequently, more contacts button icons CP1˜CP5 will appear on the updated Skype contacts menu interface IF.

In conclusion, the user is able to touch the physical button 12 to quickly access the Skype contacts menu interface via the method for quickly displaying a Skype contacts list and is able to make Skype Internet voice calls faster and more conveniently.

It should be noted that the method for quickly displaying a Skype contacts list of the present invention is not limited to the sequence of steps mentioned above. The sequence of steps mentioned above may be changed as long as the objects of the present invention are satisfied.

While the present invention has been presented and described with reference to a preferred embodiment, it will be understood by those skilled in the art that various changes and modifications can be made to the described embodiments. It is intended to include all such variations, modifications and equivalents which fall within the scope of the invention, as defined in the accompanying claims; it is to be understood that many other possible modifications and variations can be made without departing from the spirit and scope of the invention as hereinafter claimed.

What is claimed is:

1. A method for quickly displaying a Skype contacts list, applied to a portable electronic device for a user, the portable electronic device comprising a screen and a physical button, the physical button being located on one side of the screen and equally distant from the two corresponding sides of the portable electronic device, the method comprising the following steps:
receiving a command generated by the user touching the physical button; and
outputting a Skype contacts menu interface on the screen according to the command, wherein the Skype contacts menu interface comprises a plurality of contacts button icons offered to the user for making a phone call.

2. The method as claimed in claim 1, wherein the portable electronic device further comprises a touch control module, and the touch control module is electrically connected to the screen, the method further comprising the following steps:
when a first contacts button icon of the plurality of contacts button icons is displayed, detecting and acquiring a moving track of an object touching the screen;
determining if the moving track moves toward the side of the screen where the physical button is located;
if yes, searching for updated contacts information, and re-outputting the Skype contacts menu interface on the screen according to the updated contacts information.

3. A computer program for executing a method for quickly displaying a Skype contacts list after a computer loads and executes the computer program, the computer completing the execution of the method as claimed in claim 1.

4. A computer program for executing a method for quickly displaying a Skype contacts list after a computer loads and executes the computer program, the computer completing the execution of the method as claimed in claim 2.

5. A portable electronic device, comprising:
a screen;
a physical button, located on one side of the screen, and equally distant from the two corresponding sides of the portable electronic device;
a memory, used for storing a computer program for executing a method for quickly displaying a Skype contacts list; and
a processor, electrically connected to the physical button and the memory, the processor being used for executing the computer program to complete the following mechanisms:
receiving a command generated by a user touching the physical button; and
outputting a Skype contacts menu interface on the screen according to the command, wherein the Skype contacts menu interface comprises a plurality of contacts button icons offered to the user for making a phone call.

6. The portable electronic device as claimed in claim 5, further comprising a touch control module, the touch control module being electrically connected to the screen, and the processor executing the computer program to further complete the following mechanisms:
when a first contacts button icon of the plurality of contacts button icons is displayed, detecting a moving track of an object touching the screen;
determining if the moving track moves toward the side of the screen where the physical button is located;
if yes, searching for updated contacts information, and re-outputting the Skype contacts menu interface on the screen according to the updated contacts information.
